(19) United States
(12) Patent Application Publication
(10) Pub. No.: US 2025/0030232 A1
(43) Pub. Date: Jan. 23, 2025

(54) Insulator Cover Apparatus with Flip Extensions for Covering Power Lines

(71) Applicant: Custom Coating Innovations, Inc., Belleville, IL (US)

(72) Inventors: George Genung, St. Louis, MO (US); Michael Mattera, Southbury, CT (US)

(21) Appl. No.: 18/775,801

(22) Filed: Jul. 17, 2024

Related U.S. Application Data
(60) Provisional application No. 63/513,958, filed on Jul. 17, 2023.

(51) Int. Cl. H02G 7/14; H02G 1/02

(52) U.S. Cl. CPC H02G 7/14; H02G 1/02

(57) ABSTRACT

An insulator cover apparatus with flip extensions has a base of the apparatus that can be positioned over a remote portion of a power line, and has extensions of the apparatus that can then be flipped remotely from the base to cover over additional portions of the power line at opposite ends of the base to protect the covered portions of the power line.

### RELATED APPLICATIONS

This patent application claims the benefit of the filing date of Provisional Patent Application Ser. No. 63/513,958, which was filed on Jul. 17, 2023.

### FIELD OF THE INVENTION

This disclosure pertains to an insulator cover apparatus that enables a base of the apparatus to be positioned over a remote portion of a power line, and then extensions of the apparatus at opposite ends of the base to be flipped remotely from the base to cover over additional portions of the power line at opposite ends of the base to protect the covered portions of the power line.

### BACKGROUND

Protective devices are used on components of electric power distribution systems, for example power lines to protect the power lines. These devices protect the power line from damage resulting from contact with animals such as birds or contact with objects of the surrounding environment such as brush or tree branches. Protective devices of this type installed on power lines also protect birds landing on the power lines from receiving an electric shock.

Many if not most power lines of electric power distribution systems are positioned remotely or high above the ground on utility poles or other similar structures. The remote positioning of the power lines makes them difficult to access for installation of protective devices on the power lines. The remote positioning often requires that protective devices be installed by a technician using an elongate pole or “hot stick”. A hot stick is an insulated pole used in the electric power distribution industry by utility workers performing live-line work on energized high voltage electric power lines. The hot stick protects the workers from electric shock. The worker manually holds and manipulates the hot stick at the proximal end of the hot stick while using the distal end of the hot stick to hold and position a protective device on a portion of a power line of the electric power distribution system.

The current procedure for positioning protective devices on power lines of power distribution systems is very difficult to perform and very time consuming.

### SUMMARY

The insulator cover apparatus of this disclosure has a unique and non-obvious construction that enables the apparatus to be easily and quickly positioned on a remote portion of a power line of an electric power distribution system and then extended to cover over additional portions of the power line.

The cover apparatus comprises a base that has a length with opposite first and second ends. An interior bore extends through the base between the first and second ends. The interior bore is dimensioned and configured to receive a portion of a powered line in the interior bore and secure the base to the portion of the power line.

A first extension is attached to the base adjacent to the first end of the base. The first extension has an interior bore extending through the first extension. The interior bore of the first extension is also dimensioned to receive a portion of a power line in the interior bore and secure the first extension to the portion of the power line.

A first attachment attaches the first extension to the base. The first attachment enables the first extension to pivot between first and second positions of the first extension relative to the base. In the first position, the first extension extends over the base in a compact configuration of the first extension and the base. In the second position, the first extension extends from the first end of the base to where the interior bore of the first extension is aligned with the interior bore of the base.

A second extension is attached to the base adjacent to the second end of the base. The second extension has an interior bore extending through the second extension. The interior bore of the second extension is also dimensioned to receive a portion of the power line in the interior bore and secure the second extension to the portion of the power line.

A second attachment attaches the second extension to the base. The second attachment enables the second extension to pivot between first and second positions of the second extension relative to the base. In the first position, the second extension extends over the base in a compact configuration of the second extension and the base. In the second position, the second extension extends from the second end of the base to where the interior bore of the second extension is aligned with the interior bore of the base.

With the first and second extensions positioned in their first positions extending over the base, the base can be remotely positioned on a portion of a power line. The first and second extensions can then be remotely manipulated to move the first and second extensions from their first positions relative to the base to their second positions relative to the base. This positions the first and second extensions extending from the opposite first and second ends of the base in alignment with the base. This results in a length of the power line being inserted into and secured in the interior bores of the base, the first extension and the second extension.

The base, the first extension and the second extension secured to the length of the power line protect the length of the power line from damage caused by the exterior environment of the power line and from damage caused by birds landing on the power line. The combined length of the base, the first extension and the second extension secured on the power line further protects birds landing on the power line from receiving an electric shock.

### DESCRIPTION OF THE DRAWINGS

FIG. 1 is a representation of an end elevation view of the insulator cover apparatus of this disclosure with the first and second extensions of the apparatus in their first positions relative to the base of the apparatus.

FIG. 2 is a representation of a front elevation view of the apparatus with the first and second extensions in their first positions relative to the base of the apparatus, with the rear elevation view of the apparatus being a mirror image thereof.

FIG. 3 is a representation of a front elevation view of the apparatus as the first and second extensions are moved from their first positions toward their second positions relative to the base of the apparatus, with the rear elevation view of the apparatus being a mirror image thereof.

FIG. 4 is a representation of a front elevation view of the apparatus with the first and second extensions moved to their second positions relative to the base of the apparatus, with the rear elevation view of the apparatus being a mirror image thereof.

FIG. 5 is a representation of an end elevation view of the apparatus in the configuration represented in FIG. 4.

### DETAILED DESCRIPTION

The insulator cover apparatus 10 of this disclosure is configured for containing a portion of a power line of an electric power distribution system. The configuration of the apparatus 10 enables the apparatus to be easily remotely positioned over and on the portion of the power line to be protected. The apparatus 10 is constructed of a lightweight material that facilitates the remote positioning of the apparatus on a portion of a power line. The material of the apparatus 10 is an electrical insulator and is also heat resistant and fire resistant. Equivalent types of materials could be employed in the construction of the apparatus 10.

The cover apparatus 10 is comprised of a base 12 that has a general, inverted U-shaped configuration. The configuration of the base 12 has a length dimension that extends between a first end surface 14 of the base and a second end surface 16 of the base at opposite ends of the length of the base. The first 14 and second 16 end surfaces are planar and parallel surfaces.

An interior bore 18 extends through the interior of the base 12. The interior bore 18 is defined by an inverted U-shaped surface in the interior of the base 12 above the bore 18 and a plurality of spaced, opposing, flexible panels 20 extending from opposite sides of the bore 18 below the bore. The interior bore 18 has a center axis 22. The interior bore 18 extends through the length of the base from the first end surface 14 to the second end surface 16. The first end surface 14 and the second end surface 16 are both perpendicular to the center axis 22. The interior bore 18 has a cross section dimensioned and configured to receive a portion of a power line in the bore 18 and securely hold the base to the exterior surface of the portion of a power line.

A slot 24 is formed in the bottom of the base 12. The slot 24 extends through the base 12 from an exterior surface of the base to the interior bore 18. The slot 24 also extends the length of the base 12 from the first end surface 14 to the second end surface 16. The slot 24 is dimensioned and configured to enable a portion of a power line to be passed through the slot and into the interior bore 18 in the base 12. The flexible panels 20 extend into the slot 24 from opposite sides of the slot and are displaced or bent to one side by a power line inserted through the slot 24 and into the bore 18. Once the power line is pushed past the panels 20 and positioned in the bore 18, the panels 20 flex back to their original positions below the power line where the panels 20 hold the power line in the bore 18.

A first extension 26 is attached to the base 12 adjacent the first end surface 14 of the base. The first extension 26 has an elongate configuration with a length dimension that extends between a first end surface 28 of the first extension and a second end surface 32 of the first extension at opposite ends of the length of the first extension. The first 28 and second 32 end surfaces of the first extension 26 are planar and parallel surfaces.

An interior bore 34 that is similar in construction to the interior bore 18 of the base 12 extends through the interior of the first extension 26. The interior bore 34 is defined by an inverted U-shaped surface in the interior of the first extension 26 above the bore 34 and a plurality of spaced, opposing, flexible panels 35 extending from opposite sides of the bore 34 below the bore. The interior bore 34 has a center axis. The interior bore 34 extends through the length of the first extension 26 from the first end surface 28 to the second end surface 32 of the first extension. Like the interior bore 18 of the base 12, the interior bore 34 of the first extension 26 has a cross section dimensioned and configured to receive and securely hold the first extension to the exterior surface of a portion of a power line.

A slot 36 is formed in the bottom of the first extension 26. The slot 36 extends through the first extension 26 from an exterior surface of the first extension to the interior bore 34 of the first extension. The slot 36 also extends through the length of the first extension 26 from the first end surface 28 to the second end surface 32 of the first extension. The slot 36 is dimensioned and configured to enable a portion of a power line to be inserted through the slot and into the interior bore 34 of the first extension 26. The flexible panels 35 extend into the slot 36 from opposite sides of the slot and are displaced or bent to one side by a power line inserted through the slot 36 and into the bore 34. Once the power line is pushed past the panels 35 and positioned in the bore 34, the panels 35 flex back to their original positions below the power line where the panels 35 hold the power line in the bore 34.

A second extension 38 is attached to the base 12 adjacent the second end surface 16 of a base. The second extension 38 has an elongate configuration with a length dimension that extends between a first end surface 42 and a second end surface 44 of the second extension at opposite ends of the length of the second extension. The first end surface 42 and the second end surface 44 are planar and parallel surfaces.

An interior bore 46 that is similar in construction to the interior bore 18 of the base 12 extends through the interior of the second extension 38. The interior bore 46 is defined by an inverted U-shaped surface in the interior of the second extension 38 above the bore 46 and a plurality of spaced, opposing, flexible panels 47 extending from opposite sides of the bore 46 below the bore. The interior bore 46 extends through the length of the second extension 38 from the first end surface 42 to the second end surface 44 of the second extension. Like the interior bore 18 the base 12, the interior bore 46 of the second extension 38 has a cross section dimensioned and configured to receive and securely hold the second extension to the exterior surface of a portion of a power line.

A slot 48 is formed in the bottom of the second extension 38. The slot 48 extends through the second extension 38 from the exterior surface of the second extension to the interior bore 46 of the second extension. The slot 48 also extends through the length of the second extension 38 from the first end surface 42 to the second end surface 44 of the second extension. The slot 48 is dimensioned and configured to enable a portion of a power line to be inserted through the slot and into the interior bore 46 of the second extension 38. The flexible panels 47 extend into the slot 48 and are displaced or bent to one side by a power line inserted through the slot 48 and into the bore 46. Once the power line is pushed past the panels 47 and positioned in the bore 46, the panels 47 flex back to their original positions below the power line where the panels 47 hold the power line in the bore 46.

A first attachment 52 attaches the first extension 26 to the base 12. As represented in FIGS. 2, 3 and 4, the first attachment 52 is positioned on the top surface of the base 12 and on the top surface of the first extension 26 where the first attachment 52 enables the first extension 26 to be moved to a position above the base 12. The first attachment 52 is a pivot connection that enables the first extension 26 to pivot about the first attachment 52 between first and second positions of the first extension 26 relative to the base 12. In the first position the first extension 26 extends over the base 12 in a compact configuration of the first extension and the base represented in FIG. 2. In the second position the first extension 26 extends from the first end surface 14 of the base 12 to where the interior bore 34 of the first extension is axially aligned with the interior bore 18 of the base as represented in FIG. 4. With the first attachment 52 positioned on the top surface of the base 12 and the top surface of the first extension 26 the weight of the first extension 26 assists in holding the first extension down in the second position. Also as represented in FIGS. 3 and 4, the first end 28 of the first extension 26 is dimensioned to extend over the first end 14 of the base 12 in the second position of the first extension 26.

A second attachment 54 attaches the second extension 38 to the base 12. As represented in FIGS. 2, 3 and 4, the second attachment 54 is positioned on the top surface of the base 12 and on the top surface of the second extension 38 where the second attachment enables the second extension to be moved to a position above the base 12. The second attachment 54 is a pivot connection that enables the second extension 38 to pivot about the second attachment 54 between first and second positions of the second extension 38 relative to the base 12. In the first position the second extension 38 extends over the base 12 in a compact configuration of the second extension and the base represented in FIG. 2. In the second position the second extension 38 extends from the second end surface 16 of the base 12 to where the interior bore 46 of the second extension is axially aligned with the interior bore 18 of the base as represented in FIG. 4. With the second attachment 54 positioned on the top surface of the base 12 and the top surface of the second extension 38 the weight of the second extension 38 assists in holding the second extension down in the second position. Also as represented in FIGS. 3 and 4, the first end 42 of the second extension 38 is dimensioned to extend over the second end 16 of the base 12 in the second position of the second extension 38.

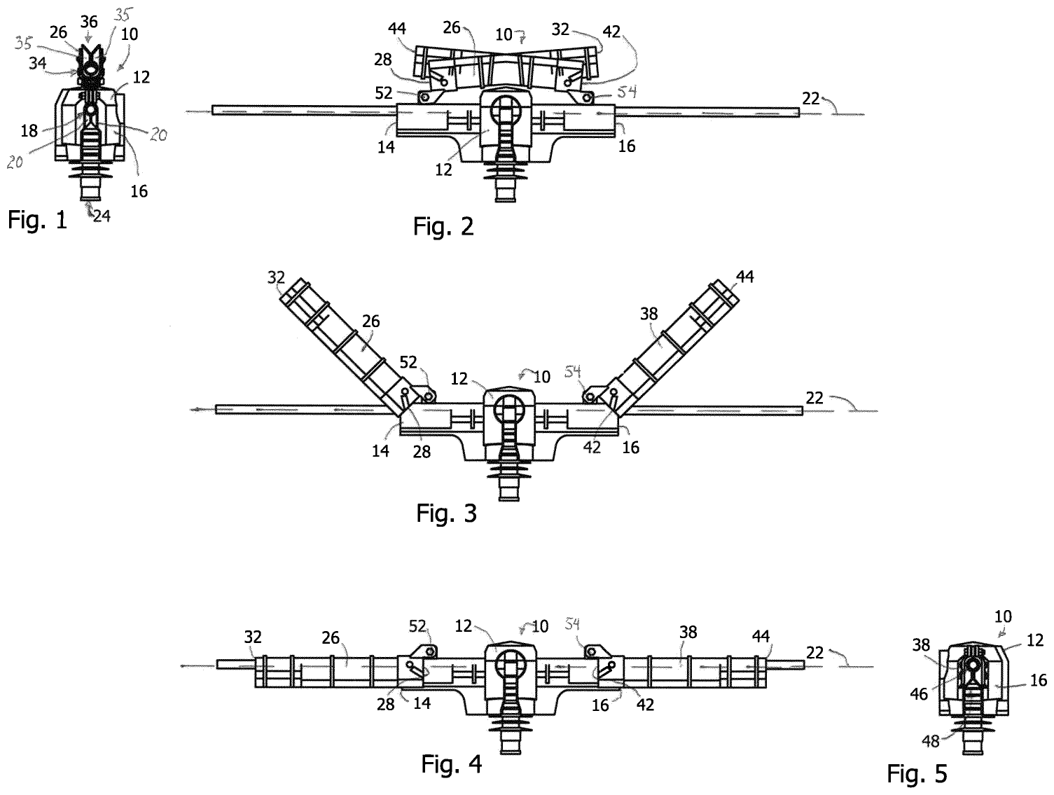

With the first 26 and second 38 extensions positioned in their first positions extending over the base 12 as represented in FIGS. 1 and 2, the base 12 can be remotely positioned on a portion of a power line. Remotely maneuvering the base 12 to insert the portion of the power line upward through the flexible panels 20 on the opposite sides of the slot 24 and into the interior bore 18 of the base secures the base to the portion of the power line. The first 26 and second 38 extensions can then be remotely manipulated to move the first and second extensions from their first positions relative to the base 12 represented in FIG. 1 and FIG. 2, to their second positions relative to the base represented in FIG. 4. This positions the first 26 and second 38 extensions extending from the opposite first 14 and second 16 end surfaces of the base 12 in alignment with the base. As the first extension 26 and second extension 38 are moved portions of the power line are inserted upward through the flexible panels 35, 47 on opposite sides of the respective slots 36, 48 and into the respective interior bores 34, 46 securing the respective first extension 26 and second extension 38 to the power line. Thus, the interior bore 34 of the first extension 26 and the interior bore 46 of the second extension 38 receive further portions of the power line as the extensions 26, 38 are moved to their second positions relative to the base 12 represented in FIG. 4. This results in a length of the power line being secured in the interior bores of the base 12, the first extension 26 and the second extension 38.

There are a plurality of projections or flanges 56 formed on the exterior of the first extension 26 and a plurality of projections or flanges 58 formed on the exterior of the second extension 38. The projections 56, 58 are configured to facilitate their being grasped or engaged by a separate tool such as hot stick used in positioning the base 12 on a portion of a power line and then manipulating and positioning the first extension 26 and the second extension 38 on the power line.

The base 12, the first extension 26 and the second extension 38 secured to the length of the power line protect the length of the power line from damage caused by the exterior environment of the power line and from damage caused by birds landing on the power line. The combined lengths of the base 12, the first extension 26 and the second extension 38 secured on the power line total at least 60 inches which is a standard maximum length of measurement from wing tip to wing tip to protect birds landing on the power line from receiving an electric shock.

As various modifications could be made in the construction of the insulator cover apparatus with flip extensions and its method of operation herein described and illustrated without departing from the scope of the invention, it is intended that all matter contained in the foregoing description or shown in the accompanying drawings shall be interpreted as illustrative only rather than limiting. Thus, the breadth and scope of the present disclosure should not be limited by any of the above described exemplary embodiments, but should be defined only in accordance with the following claims appended hereto and their equivalents.

1. A cover apparatus for covering power lines comprising:
a base, the base having a length with opposite first and second end surfaces, an interior bore extending through the base from the first end surface to the second end surface, the interior board being dimensioned and configured to receive and contain a portion of a length of a power line in the interior bore;
a first extension attached to the base adjacent the first end surface of the base, the first extension having an interior bore extending through the first extension, the interior board being dimensioned and configured to receive and contain a portion of a length of a power line in the interior bore; and
a first attachment attaching the first extension to the base, the first attachment enabling the first extension to move between first and second positions of the first extension relative to the base where in the first position the first extension is positioned extending at an angle relative to the base in a compact configuration of the first extension and the base and in the second position the first extension is positioned extending from the base where the interior bore of the base and the interior bore of the first extension are aligned.

2. The cover apparatus of claim 1, further comprising:
a second extension attached to the base adjacent to the second end surface of the base, the second extension having an interior bore extending through the second extension, the interior board being dimensioned and configured to receive and contain a portion of a length of a power line in the interior bore; and
a second attachment attaching the second extension to the base, the second attachment enabling the second extension to move between first and second positions of the second extension relative to the base where in the first position the second extension is positioned extending at an angle relative to the base in a compact configuration of the second extension and the base and in the second position the second extension is positioned extending from the base where the interior bore of the base and the interior bore of the second extension are aligned.

3. The cover apparatus of claim 2, further comprising:
in the second position of the first extension and in the second position of the second extension the interior bore of the base is axially aligned with the interior bore of the first extension and is axially aligned with the interior bore of the second extension.

4. The cover apparatus of claim 3, further comprising:
in the first position of the first extension the first extension extends from the first end of the base along the base; and
in the first position of the second extension the second extension extends from the second end of the base along the base.

5. The cover apparatus of claim 1, further comprising:
a slot in the base, the slot extends from an exterior surface of the base to the interior bore of the base, and the slot extends the length of the base between the first end surface and the second end surface.

6. The cover apparatus of claim 5, further comprising:
a slot in the first extension, the slot extends from an exterior surface of the first extension to the interior bore of the first extension.

7. The cover apparatus of claim 1, further comprising:
projections on the first extension, the projections being configured for being engaged by a separate tool and used to manipulate the first extension.

8. The cover apparatus of claim 1, further comprising:
the first attachment is a pivot connection on a top surface of the base and on a top surface of the first extension.

9. A cover apparatus for covering power lines comprising:
a base, the base having a length with opposite first and second end surfaces, an interior bore extending through the base from the first end surface to the second end surface, the interior board being dimensioned and configured to receive and contain a portion of a length of a power line in the interior bore;
a first extension attached to the base adjacent the first end surface of the base, the first extension having an interior bore extending through the first extension, the interior board being dimensioned and configured to receive and contain a portion of a length of a power line in the interior bore; and
a first attachment attaching the first extension to the base, the first attachment enabling the first extension to pivot between first and second positions of the first extension relative to the base where in the first position the first extension is positioned extending over the base in a compact configuration of the first extension and the base and in the second position the first extension is positioned extending from the base where the interior bore of the base and the interior bore of the first extension are aligned.

10. The cover apparatus of claim 9, further comprising:
a second extension attached to the base adjacent to the second end surface of the base, the second extension having an interior bore extending through the second extension, the interior board being dimensioned and configured to receive and contain a portion of a length of a power line in the interior bore; and
a second attachment attaching the second extension to the base, the second attachment enabling the second extension to pivot between first and second positions of the second extension relative to the base where in the first position the second extension is positioned extending over the base in a compact configuration of the second extension and the base and in the second position the second extension is positioned extending from the base where the interior bore of the base and the interior bore of the second extension are aligned.

11. The cover apparatus of claim 10, further comprising:
in the second position of the first extension and in the second position of the second extension the interior bore of the base is axially aligned with the interior bore of the first extension and is axially aligned with the interior bore of the second extension.

12. The cover apparatus of claim 9, further comprising:
a slot in the base, the slot extends from an exterior surface of the base to the interior bore of the base, and the slot extends the length of the base between the first end surface and the second end surface.

13. The cover apparatus of claim 12, further comprising:
a slot in the first extension, the slot extends from an exterior surface of the first extension to the interior bore of the first extension.

14. The cover apparatus of claim 9, further comprising:
projections on the first extension, the projections being configured for being engaged by a separate tool and used to manipulate the first extension.

15. The cover apparatus of claim 9, further comprising:
the first attachment is a pivot connection on a top surface of the base and on a top surface of the first extension.

16. A method of protecting power lines comprising:
positioning a base of a cover apparatus on the power line with a portion of a length of the power line received in an interior bore of the base;
moving a first extension attached to the base from a first position where the first extension is at an angled orientation relative to the base to a second position where the first extension is aligned with the base and the portion of the length of the power line is received in an interior bore of the first extension.

17. The method of claim 16, further comprising:
moving a second extension attached to the base from a first position where the second extension is at an angled orientation relative to the base to a second position where the second extension is aligned with the base and the portion of the length of the power line is received in an interior bore of the second extension.

18. The method of claim 16, further comprising:
moving the first extension with a tool that is separate from the cover apparatus.

19. The method of claim 18, further comprising:
moving the second extension with a tool that is separate from the cover apparatus.

20. The method of claim 19, further comprising:
the tool is a hot stick.
